(19) United States
(12) Patent Application Publication
(10) Pub. No.: US 2021/0149615 A1
(43) Pub. Date: May 20, 2021

(54) RELEASE OF PRINT JOBS BASED ON LOCATIONS OF PORTABLE DEVICES

(71) Applicant: Hewlett-Packard Development Company, L.P., Spring, TX (US)

(72) Inventors: Scott Rob Kaulser, Boise, ID (US); Troy Jones, Boise, ID (US); Brent Michael Bradburn, Boise, ID (US)

(73) Assignee: Hewlett-Packard Development Company, L.P., Spring, TX (US)

(21) Appl. No.: 17/047,084

(22) PCT Filed: May 9, 2018
(86) PCT No.: PCT/US2018/031735

§ 371 Date: Oct. 13, 2020

(51) Int. Cl. G06F 3/12

(52) U.S. Cl. CPC G06F 3/1296; G06F 3/1207; G06F 3/126; G06F 3/1292

(57) ABSTRACT

An example apparatus includes: a network interface to receive: a printer identifier identifying a printing device to which one or more print jobs, associated with a portable device, are to be released; and a location associated with the portable device; a memory including a pre-configured location of the printing device; and a processor connected to the network interface and the memory, the processor to execute instructions stored in the memory. The instructions are to: when the location associated with the portable device and the pre-configured location of the printing device are within a given distance, release the one or more print jobs to the printing device; and when the location associated with the portable device and the pre-configured location of the printing device are not within the given distance, prevent release of the one or more print jobs to the printing device.

### BACKGROUND

Printed documents are often used to present information. In particular, printed documents continue to be used despite the availability of electronic alternatives as they are more easily handled and read by users. Accordingly, the generation of printed documents remains an important tool for the presentation and handling of information. Printers are known and have been used to generate documents based on information received via a network.

### BRIEF DESCRIPTION OF THE DRAWINGS

Reference will now be made, by way of example only, to the accompanying drawings in which:

FIG. 1 is a block diagram of an example apparatus to handle print jobs across a network and for release of print jobs based on locations of portable devices;

FIG. 2 is a block diagram of an example portable device;

FIG. 3 is a flowchart of an example of a method for release of print jobs based on locations of portable devices;

FIG. 4 is a block diagram of another example apparatus to handle print jobs across a network and for release of print jobs based on locations of portable devices;

FIG. 5 is a schematic view of another example of the apparatus of FIG. 1;

FIG. 6 is a schematic view of another example of the apparatus of FIG. 1; and

FIG. 7 is a schematic view of another example of the apparatus of FIG. 1.

### DETAILED DESCRIPTION

A portable device may detect a printer using beacons, and the like, which advertise the printer identifier. Hence, when the portable device is close to the printer and receives the printer identifier using the beacon, the portable device may then use a cloud service to release documents in a print queue to the printer using the printer identifier. However, while convenient, there may be security tradeoffs. One such tradeoff is that any device may release documents to the printer when the printer identifier is known and/or has been acquired by malicious users; such document release may include release of hundreds or even thousands of documents to the printer which would both burn through print supplies and/or render the printer useless. Furthermore, such document release may include release and/or printing of documents that may be subject to security provisions and/or printing of documents without the permission of a person that originated the documents.

Hence, provided herein is an apparatus which receives the location of the portable device and compares it to a pre-configured location of a printer to which the portable device is attempting to release documents; for example, the pre-configured location of the printer may be stored in a memory in association with the printer identifier. When the locations are within a given distance, the apparatus releases the documents to the printer for printing. When the locations are not within a given distance, the apparatus does not release the documents to the printer for printing, and may notify the portable device and/or an administrator device of the attempt to print from a location outside the given distance. Generally, the given distance is at least outside a range of a beacon advertising and/or broadcasting the printer identifier.

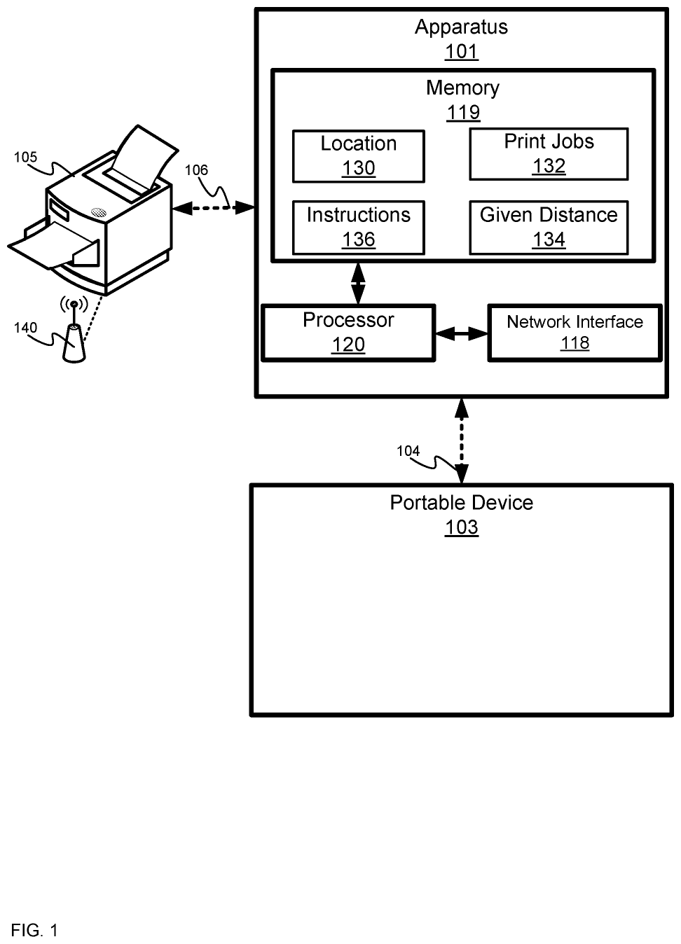

Referring to FIG. 1, an apparatus 101 to handle print jobs across a network is depicted. The apparatus 101 may include additional components, such as various additional interfaces and/or input/output devices such as displays to interact with a user or an administrator of the apparatus 101. The apparatus 101 is to receive a print job from the network, such as from a portable device 103, via a connection 104, and to transmit the print job to a printing device 105, for example via a connection 106. Hence, the apparatus 101 may be a print server and/or a cloud based device for printing to the printing device 105.

In the present example, the apparatus 101 includes a network interface 118, a memory 119, and a processor 120. The processor 120 is connected to the network interface 118 and the memory 119. The network interface 118 is to receive: a printer identifier identifying the printing device 105 to which one or more print jobs, associated with the portable device 103, are to be released; and a location associated with the portable device 103. The memory 119 includes a pre-configured location 130 of the printing device 105 including, but not limited to Global Positioning System (GPS) coordinates, and the like. The memory 119 may also store the one or more print jobs 132 associated with the portable device 103. The memory 119 also stores a given distance 134 used to determine whether to release the one or more print jobs 132 to the printing device 105. The given distance 134 may be in the same units as the location 130. The memory 119 also stores instructions 136 for release of print jobs based on locations of portable devices, for example, the location of the portable device 103 relative to the printing device 105. The given distance 134 may be stored as a component of the instructions 136 or, as depicted, separately from the instructions 136.

The processor 120 is to execute the instructions 136 stored in the memory 119, the instructions 136 to: when a location associated with the portable device 103 and the pre-configured location 130 of the printing device 105 are within a given distance 134, release the one or more print jobs 132 to the printing device 105; and when the location associated with the portable device 103 and the pre-configured location 130 of the printing device 105 are not within the given distance, prevent release of the one or more print jobs 132 to the printing device 105.

The network interface 118 is to communicate with a network such as a wired or wireless network which may include one or more of a cellular network, a WiFi network, and the like, the connections 104, 106 being via the network. The network and the connections 104, 106 may be wireless (and/or at least partially wired) as desired. In the present example, the network interface 118 is to receive a printer identifier from the portable device 103 identifying the printing device 105 to which the one or more print jobs 132 are to be released. The printer identifier may be received in a print command. The print command may further specify a number of copies of a document to be printed in a print job 132; for example, a print command may be for both releasing the one or more print jobs 132 to the printing device 105 and specifying how many copies of a document of a print job are to be printed. Alternatively, each of the one more print jobs 132 may specify a number of copies of a respective document to print at the printing device 105.

In the present example, print data may be generated at a computing device associated with the portable device 103. In this example, the computing device may be a workstation or personal computer of a user (not depicted). The user may also operate the portable device 103, and/or a portable computing device, such as a smartphone, that is generally carried by the user. In this example, it is to be appreciated that the user may work on a computing device, such as a workstation, to generate the print data representing documents to print at the printing device 105 located away from the computing device that generated the print data. The print data may be transmitted to the apparatus 101 which queues the print data for printing as the one or more print jobs 132. Alternatively, the print data may be transmitted to the apparatus 101 by the portable device 103.

The printer identifier may be received at the apparatus 101 with a location associated with the portable device 103; the location may be incorporated into a print command and/or transmitted with the print command. The location generated by the portable device 103 may be in the same units as the location 130 and/or the given distance 134. The printer identifier and the location associated with the portable device 103 may be provided to the apparatus 101 by the portable device 103; however, the printer identifier and the location associated with the portable device 103 may be provided to the apparatus 101 by a malicious device attempting to control the printing device 105 to print excessive documents, and the like.

In this example, it is understood that the printer identifier, which may include a beacon identifier, is broadcast by a beacon 140, alternatively referred to as a locating device; regardless of format, the printer identifier broadcast by the beacon 140 is associated with and/or identifies the printing device 105 located next to (as depicted) and/or which incorporates, the beacon 140. For example, the portable device 103 may be capable of communication with such beacons which may include a Bluetooth Low Energy beacon that broadcasts the printer identifier. The printer identifier may include, but is not limited to, a media access control address, and/or any other type of identifier which identifies the printing device 105.

The memory 119 is coupled to the processor 120 and may include a non-transitory machine-readable storage medium that may be any electronic, magnetic, optical, or other physical storage device. In the present example, the memory 119 stores the one or more print jobs 132 received at the network interface 118. The memory 119 further stores the location 130 of the printing device 105, for example in a database, the given distance 134 and the instructions 136. The location 130 of the printing device 105 may be stored in association with the printer identifier (and/or beacon identifier) broadcast by the beacon 140.

The non-transitory machine-readable storage medium may include, for example, random access memory (RAM), electrically-erasable programmable read-only memory (EEPROM), flash memory, a storage drive, an optical disc, and the like. The memory 119 may also be encoded with executable instructions to operate the network interface 118 and other hardware in communication with the processor 120. In other examples, it is to be appreciated that the memory 119 may be substituted with a cloud-based storage system.

The memory 119 may also store an operating system that is executable by the processor 120 to provide general functionality to the apparatus 101, for example, functionality to support various applications such as a user interface to access various features of the apparatus 101. Examples of operating systems include Windows™, MacOS™, iOS™, Android™, Linux™, and Unix™. The memory 119 may additionally store applications that are executable by the processor 120 to provide specific functionality to the apparatus 101, such as those described in greater detail below and which may include the instructions 136.

The processor 120 may include a central processing unit (CPU), a microcontroller, a microprocessor, a processing core, a field-programmable gate array (FPGA), or similar. The processor 120 and memory 119 may cooperate to execute various instructions such as the instructions 136.

In addition, the apparatus 101 may include a print engine to generate the one or more print jobs 132 to print at the printing device 105. In an example, the print engine routes the one or more print jobs 132 to the printing device 105 upon receiving a print command from the portable device 103. In other examples, the print command may be automatically generated when a direct connection between the portable device 103 and the printing device 105, such as via a Bluetooth connection with the beacon 140 is established, to indicate that the portable device 103 is close enough to the printing device 105 such that a user of the portable device 103 may collect the document after it is generated by the printing device 105.

Accordingly, the processor 120 may execute instructions stored on the memory 119 to implement the print engine and/or to handle and manage the one or more print jobs 132 across a network. It is to be appreciated that in other examples, the print engine may be substituted with an external engine, such as another server or machine, or carried out by a virtual machine in the cloud.

In addition, the apparatus 101 may further include an applications programming interface (API) for receiving print commands and locations of devices transmitting the print commands. The API may be to receive the printer identifier and the location of the portable device 103 transmitting the printer identifier according to a given format. For example, the API may require that the location of the printing device, identified by the printer identifier, be received in order to release the one or more print jobs 132.

The processor 120 is also to control and/or monitor the network interface 118. For example, the processor 120 is to monitor the printer identifiers and/or locations and/or print commands received that are associated with the portable device 103.

The processor 120 is also to, when the location associated with the portable device 103 and the pre-configured location 130 of the printing device are within the given distance 134, release the one or more print jobs 132 to the printing device 105; and when the location associated with the portable device 103 and the pre-configured location 130 of the printing device are not within the given distance, prevent release of the one or more print jobs 132 to the printing device 105.

The given distance 134 is selected to prevent a malicious attack on the printing device 105. For example, the given distance 134 may be smaller than a range of the beacon 140 broadcasting the printer identifier, and may be greater than a distance from the beacon 140 to a location outside a building within which the beacon 140 and the printing device 105 are located. In general, the given distance 134 is selected to prevent another device, which has access to the printer identifier, and which may further spoof the identity of the portable device 103, to release the one or more print jobs 132 to the printing device 105. For example, the given distance 134 is selected to prevent release of the one or more printing jobs to the printing device 105 when the location 130 of the printing device 105 and a location of the portable device 103 received with a print command are in different geographic locations such as different counties and/or cities and/or counties.

In some of these examples, the processor 120 may also be to, when the location is not received with the printer identifier, prevent release of the one or more print jobs 132 to the printing device 105. In these examples, unless the location is received with the printer identifier, the one or more print jobs 132 are not released to the printing device 105.

The processor 120 may also be to: notify one or more of the portable device 103 and an administrator device when the location associated with the portable device 103 and the pre-configured location 130 of the printing device 105 are not within the given distance 134.

The processor 120 may also be to: notify one or more of the portable device 103 and an administrator device when commands to release print jobs are received from different locations. For example, a print command to release the one or more print jobs 132 may be received from different geographic locations, such as different countries, different counties, different cities, and the like, within a given period of time, and the processor 120 may be to responsively prevent the release of the one or more print jobs 132.

The processor 120 may also be to: notify one or more of the portable device 103 and an administrator device when commands to release the one or more print jobs 132 to a different printing device are received within a given time period.

The processor 120 may also be to: notify one or more of the portable device 103 and an administrator device when an identifier associated with the portable device 103 is received in log-in data from different locations with a given time period. For example, in these examples, a badge, and the like, of the user operating the portable device 103 may be used to wirelessly log into the apparatus 101 using a badge reader; the badge and the badge reader may include, but are not limited to radio frequency identification (RFID) components. For example, the badge may store an identifier of the user, such as an employee number, and the like, which is also associated with the portable device 103. The badge reader may read the identifier from the badge and communicate with the apparatus 101 to log the user, as well as the portable device 103, into the apparatus 101. Such a badge reader may be located at the printing device 105 and/or such a badge reader may be located at entrances to rooms and/or building in which the printing device 105 is located. When the identifier is received at the apparatus 101 from different geographic locations within a given time period, for example different countries and/or different counties and/or different cities within a 10-minute time period (which may be configurable), the processor 120 may one or more of: deny the log-in and notify one or more of the portable device 103 and an administrator device of the attempted log-ins from different geographic locations. In such examples, the attempted log-ins from different geographic locations within a given time period (which may be shorter or longer than 10 minutes and/or configurable), are considered suspicious behavior as a malicious user may be attempting to log-in from another location. The processor 120 maybe further to prevent actions associated with such attempted log-ins; in particular, at least one of the log-ins may be prevented. Alternatively, the user may be automatically logged out of the apparatus 101. In these examples, the processor 120 may determine a location of the attempted log-in via a pre-configured location of the badge reader where the identifier is received.

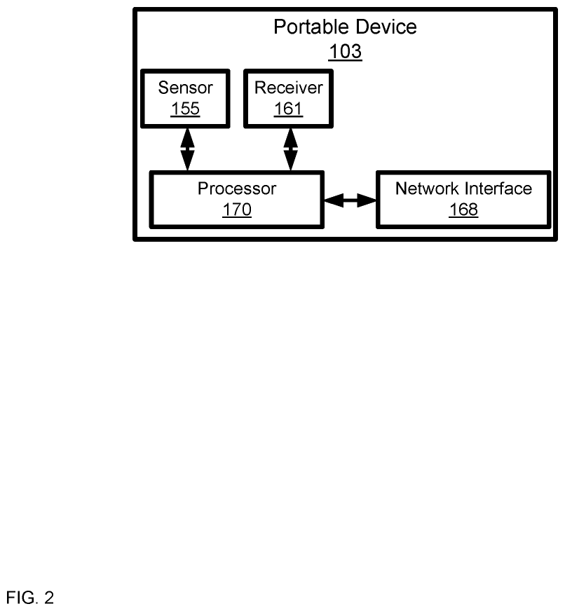

FIG. 2 depicts a schematic block diagram of the portable device 103. The portable device 103 may include additional components, such as various additional interfaces and/or input/output devices such as displays to interact with a user of the portable device 103. The portable device 103 is to provide a print command and a location of the portable device 103. Accordingly, it is to be assumed that the portable device 103 may generally be carried by a user. For example, the portable device 103 may be a smartphone or a wearable device such as a smartwatch. In the present example, the portable device 103 includes a sensor 155 to detect signals, a receiver 161 to receive GPS data, and the like, a network interface 168, and a processor 170.

The sensor 155 is not particularly limited and is to detect a signal. In particular, the sensor 155 is to detect a printer identifier to identify the location of the associated printer, for example a printer identifier identifying the printing device 105 as broadcast by the beacon 140. As an example of a printing system, a plurality of beacons may be positioned within a space, such as an office building. In the present example, each beacon may be may be disposed through the space and emit a signal with a unique printer identifier (and/or a beacon identifier associated with a printing device). The beacons may be provided on a one-to-one basis with associated printing devices. The sensor 155 may receive the signal and the printer identifier. The signals received by the sensor 155 are not particularly limited and may include a Bluetooth low energy signal, Wi-Fi, near field communication, radio waves, and GPS location data indicating geo-fence or geo-proximity.

The receiver 161 is also not particularly limited and is to determine a GPS coordinate based on GPS data, and the like.

The network interface 168 is to communicate with a network such as a wireless network which may include a cellular network or a local network, such as a Wi-Fi network. In the present example, the network interface 168 is to transmit the printer identifier and an associated location (and/or a print command) to the apparatus 101. In addition, the network interface 168 may be to receive a notification from the apparatus 101 for example of the one or more print jobs 132 being released to the printing device 105 and/or of the one more print jobs 132 being prevented from being released to the printing device 105.

The processor 170 may include a central processing unit (CPU), a microcontroller, a microprocessor, a processing core, a field-programmable gate array (FPGA), or similar. The processor 170 may be to execute various instructions. In the present example, the processor 170 is to transmit a printer identifier and a location associated with the portable device 103 based on input received via the sensor 155 and the receiver 161. In some examples, the processor 120 may generate a print command which includes a printer identifier and a location associated with the portable device 103. In some examples, the processor 170 may execute instructions to handle and manage print jobs across a network.

The processor 170 is also to control the network interface 168. For example, the processor 170 is to monitor the printer identifiers received from beacons, and may periodically send print commands and locations to the apparatus 101.

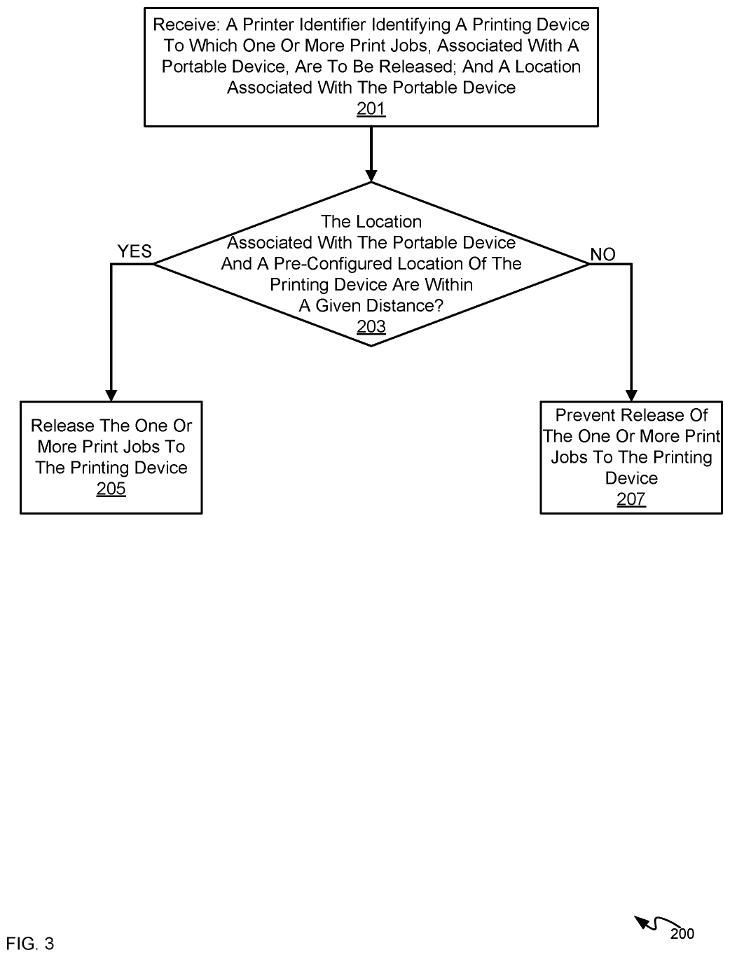

Referring to FIG. 3, a flowchart of a method 200 for release of print jobs based on locations of portable devices. In order to assist in the explanation of method 200, it will be assumed that method 200 may be performed with the apparatus 101, and specifically by the processor 120. Indeed, the method 200 may be one way in which apparatus 101 may be configured to interact with the portable device 103 and the printing device 105. Furthermore, the following discussion of method 200 may lead to a further understanding of the processor 120, and apparatus 101 and its various components. Furthermore, it is to be emphasized, that method 200 may not be performed in the exact sequence as shown, and various blocks may be performed in parallel rather than in sequence, or in a different sequence altogether.

Beginning at block 201, the processor 120 receives, via the network interface 118, a printer identifier identifying a printing device to which one or more print jobs, associated with a portable device, are to be released; and a location associated with the portable device. For example, the printer identifier and the location may be received from the portable device 103 via a network and or the connection 104, for example using a print command. In some examples, the one or more print jobs may be received with the printer identifier and the location and/or the one or more print jobs.

The manner by which a print job is stored by the processor 120 is not particularly limited. For example, a print job may be stored in a database or queue of the memory 119. It is to be appreciated that that processor 120 may receive multiple print jobs from multiple computing devices that may be associated with different user accounts. For example, when the apparatus 101 is a print server, the apparatus 101 may be used to collect all print jobs and manage sending the print jobs to various printing devices for generating documents. Therefore, the memory 119 may include multiple databases and queues to organize the print jobs that are received via the network.

In most examples, it is to be understood that a computing device from which a print job is received may be a workstation or personal computer on which a user performs the majority of work. For example, the user may prepare a document in a word processing program and upon completion of the preparation document, send the document to the apparatus 101 for printing. The user also carries the portable device 103, such as a smartphone. When the portable device 103 approaches a printing device, the portable device 103 receives the printer identifier (and the like) broadcast by an associated beacon and may automatically provide an application which requests (e.g. via a display device) whether to release the print jobs associated with the portable device 103 to the printing device. The user of the portable device 103 may interact with the application, and optionally input a number of associated documents to print, and cause a print command with the printer identifier and the location associated with the portable device 103 to be transmitted to the apparatus 101, which are received at the block 201.

At a block 203, the processor 120 determines whether the location associated with the portable device and a pre-configured location of the printing device are within the given distance. For example, the processor 120 may determine a distance between the location of the portable device 103 and the preconfigured location 130 of the printing device 105 and compare the distance with the given distance 134. When the distance between the location of the portable device 103 and the preconfigured location 130 of the printing device 105 is less than or equal to the given distance 134, the processor 120 may determine that the location associated with the portable device 103 and the pre-configured location 130 of the printing device 105 are within the given distance 134. However, when the distance between the location of the portable device 103 and the preconfigured location 130 of the printing device 105 is greater than the given distance 134, the processor 120 may determine that the location associated with the portable device 103 and the pre-configured location 130 of the printing device 105 are not within the given distance 134.

When the location associated with the portable device and the pre-configured location of the printing device are within a given distance, at a block 205, the processor 120 releases the one or more print jobs to the printing device. For example, the processor 120 may release the one or more print jobs 132 to the printing device 105 via a network and/or the connection 106. The processor 120 may optionally notify the portable device 103 when the one or more print jobs 132 are released.

However, when the location associated with the portable device and the pre-configured location of the printing device is not within a given distance, at a block 207, the processor 120 prevents release of the one or more print jobs to the printing device. For example, the processor 120 may prevent the one or more print jobs 132 from being released to the printing device 105. The processor 120 may optionally notify the portable device 103 when the location associated with the portable device 103 and the pre-configured location 130 of the printing device 105 are not within the given distance 134. The processor 120 may optionally notify an administrator device when the location associated with the portable device 103 and the pre-configured location 130 of the printing device 105 are not within the given distance 134.

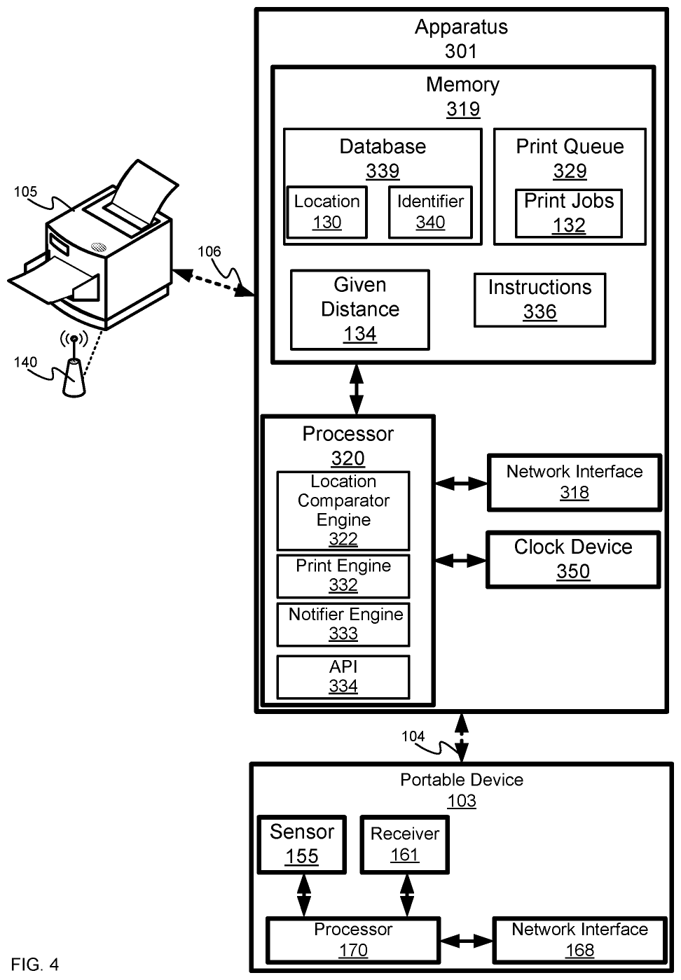

Referring to FIG. 4, another example of an apparatus 301 to handle print jobs across a network is depicted. Like components of the apparatus 301 bear like reference to their counterparts in the apparatus 101, except in a “300” series rather than in a “100” series. Furthermore, the apparatus 301 may include all the functionality of the apparatus 101 as described above. The apparatus 301 includes a network interface 318, a memory 319, and a processor 320. The processor 320 may be to operate a location comparator engine 322, print engine 332, and a notifier engine 333, an applications programming interface (API) 334, as well as carry out a set of instructions 336 to operate the apparatus 301 in general. In addition, the apparatus 301 may be connected to the portable device 103 and the printing device 105 via the connections 104, 106, respectively. Accordingly, the apparatus 301 is another example that may be used to carry out the method 200.

The network interface 318 is to communicate with a network, such as a wireless network, to receive a print job 132 from a computing device. In the present example, the computing device from which a print job 132 is received is not particularly limited and may be a laptop, smartphone, smartwatch, computer, tablet, or other electronic device capable of generating print jobs. The network interface 318 is also to communicate and receive print commands and the location from the portable device 103.

The memory 319 is coupled to the processor 320 and may include a non-transitory machine-readable storage medium that may be any electronic, magnetic, optical, or other physical storage device. In the present example, the memory 319 stores the one or more print jobs 132 in a print queue 329, the one or more print jobs 132 received at the network interface 318. As depicted, the memory 319 further stores the pre-configured location 130 of the printing device 105 in a database 339, for example in association with a printer identifier 340 which identifies the printing device 105 and which may be broadcast by the beacon 140.

The non-transitory machine-readable storage medium may include, for example, random access memory (RAM), electrically-erasable programmable read-only memory (EEPROM), flash memory, a storage drive, an optical disc, and the like. The memory 319 may also be encoded with executable instructions to operate the network interface 318 and other hardware, such as various input and output devices like a monitor, keyboard or pointing device to allow a user or administrator to operate the apparatus 301.

The memory 319 may also store an operating system that is executable by the processor 320 to provide general functionality to the apparatus 301, for example, functionality to support various applications such as a user interface to access various features of the apparatus 301. Examples of operating systems include Windows™, MacOS™, iOS™, Android™, Linux™, and Unix™. The memory 319 may additionally store applications that are executable by the processor 320 to provide specific functionality to the apparatus 301.

For example, the database 339 may include a list of the printing devices along with an identifier for each printing device, such as a media access control address, as well as characteristics of each printing device, such as duplex capabilities, color printing capabilities, geolocation of the printing device, and other finishing options. In addition, the database 339 further includes the location of each printing device. Indeed, the database 339 may store a plurality of pre-configured locations of printing devices in association with printer identifiers broadcast by respective beacons. The database 339 may include whether a printing device is considered to be part of a secure network.

The memory 319 may also store and maintain the print queue 329. In the present example, the print queue 329 may be to store the one or more print jobs 132 received via the network interface 318. The print queue 329 is not particularly limited and may include multiple queues for multiple printing devices. In the present example, the print queue 329 may be used to store the one or more print jobs 132 when a connection (not depicted) between the portable device 103 and the printing device 105 is not secure for subsequent pull printing.

Although the present example illustrates one database 339 and a single print queue 329, it is to be appreciated that the memory 319 is not particularly limited and that additional databases may be maintained to store additional data, such as context data of the portable device 103 and/or other portable devices. In addition, an organization may have printing devices connected via various networks which may have different levels of security protocols. Accordingly, each group of printing devices connected to a single network may have information stored in a separate database. Similarly, multiple print queues may be provided such that each printing device is associated with a single print queue.

The processor 320 may include a central processing unit (CPU), a microcontroller, a microprocessor, a processing core, a field-programmable gate array (FPGA), or similar. The processor 320 and memory 319 may cooperate to execute various instructions. In this example, the processor 320 also maintains and operates a location comparator engine 322 to compare a distance between a location of a device from which a print command is received (e.g. the portable device 103) and the location 130 of the printing device 105 with the given distance 134.

The processor 320 also maintains and operates the print engine 332 to route a print job generated from the print data to a printing device. In the present example, the print engine 332 automatically routes the one or more print jobs 132 to the printing device 105 based on whether the location comparator engine 322 determines whether the location associated with the portable device 103 and the pre-configured location 130 of the printing device 105 are within the given distance 134, or not within the given distance 134.

The processor 320 also maintains and operates the notifier engine 333 to notify one or more the portable device 103 and an administrator device when suspicious interactions occur between a device and a printer, such as between the portable device 103 and the printing device 105.

The processor 320 also maintains and operates the API 334 to act as a portal to the location comparator engine 322 and the print engine 332. The API 334 may be to receive the printer identifier and the location of the portable device 103 transmitting the printer identifier according to a given format.

In the present example, the apparatus 301 further comprises a clock device 350 to determined when the printer identifiers are received with the locations.

The processor 320 and/or the instructions 336 are generally to when the location comparator engine 322 determines that the location associated with the portable device 103 and the pre-configured location 130 of the printing device 105 are within a given distance, release the one or more print jobs 132 to the printing device 105 using the print engine 332; and when the location comparator engine 322 determines that the location associated with the portable device 103 and the pre-configured location 130 of the printing device 105 are not within the given distance 134, prevent the print engine 332 from releasing the one or more print jobs 132 to the printing device 105.

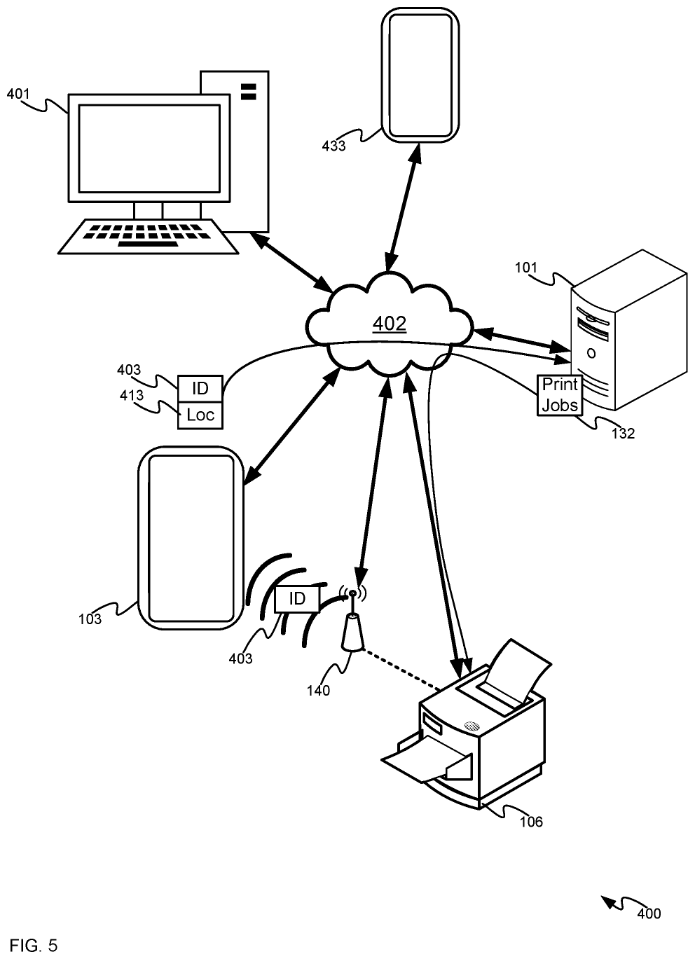

Referring to FIG. 5, a schematic representation of a network system 400. The system 400 includes the apparatus 101, an administrator device 401, such as a desktop computer, the portable device 103, such as a laptop, a smartphone, a smartwatch, a desktop computer, or a tablet, the printing device 105, and the beacon 140. In this example, the apparatus 101, the administrator device 401, the portable device 103, the printing device 105, and the beacon 140 are connected to the same network 402. As depicted, the beacon 140 is broadcasting a printer identifier 403 which identifies the printing device 105, which is received at the portable device 103.

The network 402 in this example may be a local area network, a wide area network, the Internet, and the like, and may be wired, wireless, or a combination of wired and wireless. In the present example, the network 402 and/or portions of the network 402, may be a secure network for providing a secure connection between at least some of the devices connected to the network 402.

In this example, the portable device 103 receives the printer identifier 403 and transmits the printer identifier 403 to the apparatus 101 with a location 413 of the portable device 103, for example in a print command. The apparatus 101 receives the printer identifier 403 and the location 413 and determines whether the location 413 associated with the portable device 103 and the pre-configured location 130 of the printing device 105 are within the given distance 134. Assuming that the location 413 associated with the portable device 103 and the pre-configured location 130 of the printing device 105 are within the given distance 134, the apparatus 101 releases the one or more print jobs 132 to the printing device 105.

Also depicted in the system 400 is a device 433, which may be a device of a user that has obtained the printer identifier 403 as well as the identifier of the user used to log-in to the apparatus 101, and a format to use with an API of the apparatus 101, similar to the API 334. The user of the device 433 may wish to cause the printing device 105 to print the one or more print jobs 132 and/or many copies of associated documents, in order to cause the printing device 105 to waste paper and/or ink resources and/or to waste processing resources of the printing device 105 and/or to print documents that may be subject to security provisions and/or printing of documents without the permission of a person that originated the documents, as part of a malicious attack on the printing device 105. While the device 433 is depicted as a portable device, the device 433 may comprise a personal computer, a laptop and the like.

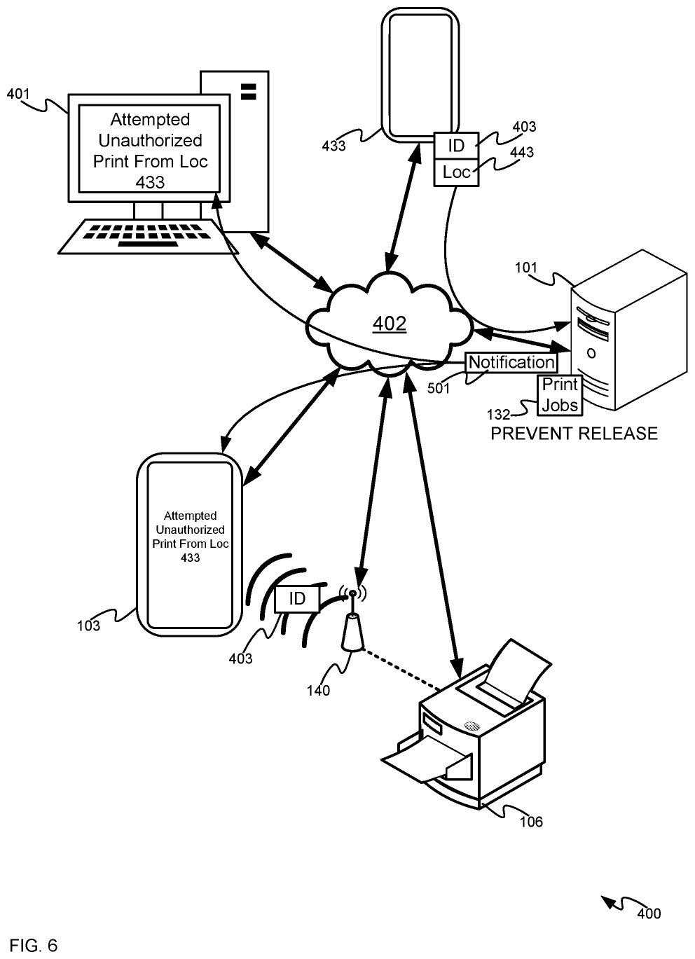

For example, attention is next directed to FIG. 6 which is substantially similar to FIG. 5 with like elements having like numbers. In FIG. 6, the device 433 transmits (for example in a print command that has the format for an API of the apparatus 101) the printer identifier 403 to the apparatus 101 with a location 443, which may be the location of the device 433 and/or a guess by a user of the device 433 as to the location of the portable device 103. The apparatus 101 receives the printer identifier 403 and the location 443 and determines whether the location 443 associated with the device 433 and the pre-configured location 130 of the printing device 105 are within the given distance 134. Assuming that the location 443 associated with the device 433 and the pre-configured location 130 of the printing device 105 are not within the given distance 134, the apparatus 101 prevents release of the one or more print jobs 132 to the printing device 105. For example, as depicted, and in contrast to FIG. 5, the one or more print jobs 132 are not released to the printing device 105.

Hence, the printing device 105 is prevented from wasting paper and/or ink resources and/or prevented from wasting processing resources of the printing device 105 and/or prevented from printing documents that may be subject to security provisions and/or prevented from printing of documents without the permission of a person that originated the documents, for example as part of a malicious attack on the printing device 105.

Furthermore, as depicted, the apparatus 101 transmits a notification 501 to the administrator device 401 and the portable device 103 of the attempted release of the one or more print jobs 132. The notification 501 may include the location 443. In the depicted example, the notification 501 is rendered at a respective display device of each of the administrator device 401 and the portable device 103, along with the location 443.

A notification, similar to the notification 501, may also be transmitted to one or more of the administrator device 401 and the portable device 103 when commands to release print jobs are received from different locations. For example, print commands to release the one or more print jobs 132 may be received at the apparatus 101 from both the portable device 103 and the device 433, and a notification, similar to the notification 501, may be transmitted to one or more of the administrator device 401 and the portable device 103. In some examples, such a notification is transmitted when commands to release the one or more print jobs 132 are received from different locations within a given time period, for example 10 minutes.

In some examples, the user of the device 433 may have obtained the printer identifier of a printing device different from the printing device 105 and may attempt to cause the different printing device to print the one or more print jobs 132 and/or many copies of the associated documents, in order to cause the different printing device to waste paper and/or ink resources and/or to waste processing resources of the different printing device and/or to print documents that may be subject to security provisions and/or printing of documents without the permission of a person that originated the documents, for example as part of a malicious attack. Hence, a print command from the device 433 may be received at the apparatus 101 to release the one or more print jobs 132 to the different printing device within a given time period of the apparatus 101 receiving a print command from the portable device 103 to release the one or more print jobs 132 to the printing device 105. In this example, a notification, similar to the notification 501, may be transmitted to one or more of the administrator device 401 and the portable device 103 when commands to release the one or more print jobs 132 to different printing devices are received within a given time period, for example 10 minutes

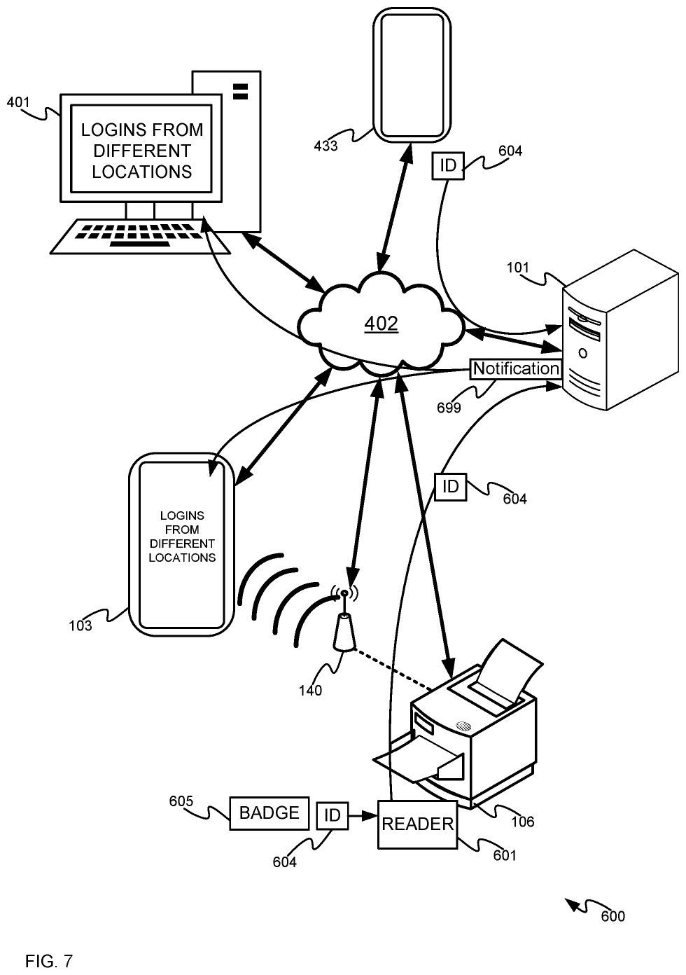

Attention is next directed to FIG. 7 which depicts a schematic representation of a network system 600 which is substantially similar to the system 400 with like elements having like numbers. However, the system 600 includes a badge reader 601 at the printing device 105, which reads an identifier 604 associated with the portable device 103 from a badge 605, for example in log-in data. The reader 601 transmits the identifier 604 to the apparatus 101 in log-in data, which may identify a user associated with the portable device 103, as part of a log-in process. The identifier 604 may be transmitted to the apparatus 101 with a location of the reader 601 and/or with an identifier of the reader 601 that is stored in the apparatus 101 with a location of the reader 601; either way, in these examples, the apparatus 101 is further to determine a location where log-in data is received, for example by an API to receive log-in data in a particular format that includes data that enables the apparatus 101 to determine a location where log-in data is received.

Also depicted in FIG. 7, the device 433 also transmits the identifier 604 to the apparatus 101, for example in log-in data, to attempt to log-in to the apparatus 101, for example maliciously. Alternatively, the user of the device 433 may have a badge similar to the badge 605 and may attempt to log into the apparatus 101 using the badge using another reader, similar to the reader 601. The identifier 604 from the device 433 may be received with an associated location and/or an identifier of a reader which reads the identifier from a badge of the user of the device 433. Either way, in these examples, the apparatus 101 is further to determine a location where log-in data is received, for example by an API to receive log-in data in a particular format that includes data that enables the apparatus 101 to determine a location where log-in data is received.

Furthermore, as depicted, the apparatus 101 transmits a notification 699 to the administrator device 401 and the portable device 103 when the identifier 604 associated with the portable device 103 is received in log-in data from different locations with a given time period. In the depicted example, the notification 699 is rendered at a respective display device of each of the administrator device 401 and the portable device 103. While not depicted, the notification 699 may include the locations of the attempted log-ins

It should be recognized that features and aspects of the various examples provided above may be combined into further examples that also fall within the scope of the present disclosure.

1. An apparatus comprising:
a network interface to receive: a printer identifier identifying a printing device to which one or more print jobs, associated with a portable device, are to be released; and a location associated with the portable device;
a memory including a pre-configured location of the printing device; and
a processor connected to the network interface and the memory, the processor to execute instructions stored in the memory, the instructions to: when the location associated with the portable device and the pre-configured location of the printing device are within a given distance, release the one or more print jobs to the printing device; and when the location associated with the portable device and the pre-configured location of the printing device are not within the given distance, prevent release of the one or more print jobs to the printing device.

2. The apparatus of claim 1, wherein the instructions are further to notify one or more of the portable device and an administrator device when the location associated with the portable device and the pre-configured location of the printing device are not within the given distance.

3. The apparatus of claim 1, wherein the instructions are further to notify one or more of the portable device and an administrator device when commands to release print jobs are received from different locations.

4. The apparatus of claim 1, wherein the instructions are further to notify one or more of the portable device and an administrator device when commands to release the one or more print jobs to a different printing device are received within a given time period.

5. The apparatus of claim 1, wherein the instructions are further to notify one or more of the portable device and an administrator device when an identifier associated with the portable device is received in log-in data from different locations with a given time period.

6. A non-transitory machine-readable storage medium encoded with instructions executable by a processor, the non-transitory machine-readable storage medium comprising:
instructions to receive: a printer identifier identifying a printing device to which one or more print jobs, associated with a portable device, are to be released; and a location associated with the portable device;
instructions to retrieve a pre-configured location of the printing device from a memory;
instructions to: when the location associated with the portable device and the pre-configured location of the printing device are within a given distance, release the one or more print jobs to the printing device; and
instructions to: when the location associated with the portable device and the pre-configured location of the printing device are not within the given distance, prevent release of the one or more print jobs to the printing device.

7. The non-transitory machine-readable storage medium of claim 6, further comprising instructions to: notify one or more of the portable device and an administrator device when the location associated with the portable device and the pre-configured location of the printing device are not within the given distance.

8. The non-transitory machine-readable storage medium of claim 6, further comprising instructions to: notify one or more of the portable device and an administrator device when commands to release print jobs are received from different locations.

9. The non-transitory machine-readable storage medium of claim 6, further comprising instructions to: notify one or more of the portable device and an administrator device when commands to release the one or more print jobs to a different printing device are received within a given time period.

10. The non-transitory machine-readable storage medium of claim 6, further comprising instructions to: notify one or more of the portable device and an administrator device when an identifier associated with the portable device is received in log-in data from different locations with a given time period.

11. An apparatus comprising:
a network interface to receive: a printer identifier identifying a printing device to which one or more print jobs, associated with a portable device, are to be released; and a location associated with the portable device;
a memory including a database storing a pre-configured location of the printing device;
a print engine to manage the one or more print jobs in a print queue;
a processor connected to the network interface and the memory, the processor to execute instructions stored in the memory, the instructions to implement a location comparator engine and the print engine, the instructions to, when the location comparator engine determines that the location associated with the portable device and the pre-configured location of the printing device are within a given distance, release the one or more print jobs to the printing device using the print engine; and when the location comparator engine determines that the location associated with the portable device and the pre-configured location of the printing device are not within the given distance, prevent the print engine from releasing the one or more print jobs to the printing device.

12. The apparatus of claim 11, further comprising a notifier engine, wherein the instructions are further to notify one or more of the portable device and an administrator device, using the notifier engine, when the location associated with the portable device and the pre-configured location of the printing device are not within the given distance.

13. The apparatus of claim 11, further comprising a notifier engine, wherein the instructions are further to notify one or more of the portable device and an administrator device, using the notifier engine, when commands to release print jobs are received from different locations.

14. The apparatus of claim 11, further comprising a notifier engine, wherein the instructions are further to notify one or more of the portable device and an administrator device, using the notifier engine, when commands to release the one or more print jobs to a different printing device are received within a given time period.

15. The apparatus of claim 11, further comprising a clock device and a notifier engine, wherein the instructions are further to notify one or more the portable device and an administrator device, using the notifier engine, when an identifier associated with the portable device is received in log-in data from different locations with a given time period.
